(19) United States
(12) Patent Application Publication
(10) Pub. No.: US 2003/0124315 A1
(43) Pub. Date: Jul. 3, 2003

(54) Reflective, lateral heat distributing insulation blanket

(76) Inventor: Chester F. Grochoski, Spring Lake, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/034,396

(22) Filed: Dec. 28, 2001

(51) Int. Cl. B32B 3/30

(52) U.S. Cl. 428/180

(57) ABSTRACT

A reflective insulative blanket for use in construction applications, such as curing concrete, thawing frozen ground and other insulative purposes. The blanket comprises at least one moisture-impervious layer attached to an insulative layer. The insulative layer includes a plurality of hollow, insulative elements. The moisture-impervious layer may close the insulative elements and/or the space surrounding the insulative elements, thereby entrapping air to provide the insulative properties of the blanket. The blanket preferably includes two moisture-impervious layers, one attached to each side of the insulative layer. The blanket further includes a reflective layer secured to the outside of at least one of the moisture-impervious layers. The reflective layer reflects thermal energy before it has passed through any portion of the blanket, thereby reducing heat retention within the blanket and improving lateral thermal conduction.

### BACKGROUND OF THE INVENTION

I. Field of the Invention

The present invention relates to insulative blankets and more particularly, to a reflective insulative lateral heat distributing blanket for use in construction applications.

II. Description of the Related Art

Construction projects many times require the maintenance of a set temperature range for curing concrete, and preventing pipes or other materials from freezing. This can often be achieved with a certain degree of success by laying an insulating material over the appropriate area. In some applications, it may be necessary to supply an area with supplementary heat. For example, in some geographical areas it may be necessary to supply supplementary heat to thaw the ground before roads, pipes, foundations or concrete floors may be laid, or repairs can be made to existing infrastructure. During cold weather concreting it may be necessary to supply supplementary heat to protect freshly placed concrete from freezing. To assure timely development of strength, it may be necessary to maintain concrete placements at temperatures well in excess of cold weather ambient air temperatures for a period of several days. This heating is typically accomplished by placing any of a variety of conventional hydronic heating elements on the ground or concrete, usually in a serpentine fashion, beneath the insulating materials.

Historically, a variety of insulative materials such as sawdust, straw, wool blankets, and bats of foam or fiberglass insulation have been used in construction projects to maintain a desired temperature range and to retain heat from heating elements. These materials are problematic because they can be cumbersome, dirty, time consuming to apply, expensive, hard to remove and difficult to move or reuse. Further, these materials may absorb moisture from the ground, wet, freshly poured concrete, or surrounding elements, thereby reducing the insulative properties of the insulative materials and potentially impairing the concrete curing process. In addition, these materials are often deficient when used in conjunction with heating elements because they do not provide lateral conduction of heat, thereby causing uneven surface temperatures.

Insulative blankets have become a common alternative to the traditional insulating materials discussed above. One such insulative blanket is shown in FIG. 1 and generally includes a type of “bubble wrap” insulative layer 102 and an aluminum foil layer 100 laminated to the upper surface of the insulative layer 102. The blanket in FIG. 1 further includes moisture-impervious layers 104a and 104b disposed on opposite sides of the laminated insulative layer 102 and aluminum foil 100. In use, emitted radiant energy radiates upwardly from the ground (or heating elements), passing through the moisture-impervious layer 104a and the insulative layer 102 before reaching the reflective aluminum foil layer 100. The emitted radiant energy is then reflected by the aluminum foil layer 100 back through the insulative-layer 102 and the moisture-impervious layer 104a. As the emitted radiant energy passes through the moisture-impervious layer 104a and the insulative layer 102, some of it is converted into heat and is retained by the blanket, thereby reducing the amount of heat energy that is returned to the ground. In applications where hydronic or other heating elements are used to provide supplementary heat, the inherent heat retention of the blanket may not provide adequate and uniform lateral heat distribution. This can in turn result in uneven temperatures across the concrete or ground. This shortcoming is typically addressed by laying the heating elements in closer proximity, thereby requiring more heating elements over a given area or decreasing the area being heated. Even if the heating elements are laid in closer proximity, the insulative blanket is not conducive to conducting heat, thereby, preventing lateral uniformity of temperature across the concrete or ground.

### SUMMARY OF THE INVENTION

The noted problems are overcome by the present invention wherein an insulative blanket is provided with an external reflective layer. In a preferred embodiment, the insulative blanket includes an insulative layer sandwiched between a pair of moisture-impervious layers. The reflective layer is secured to the outside surface of one of the moisture-impervious layers to reflect emitted radiant energy before it has passed through any portion of the blanket. The metal foil being in direct contact with heating elements also allows the foil to conduct heat laterally providing a more uniform distribution of heat to the concrete or ground.

In a more preferred embodiment, the insulative layer is formed out of a plastic material having a plurality of indentations. The moisture-impervious layers are secured to both sides of the insulative layer, sealing the indentations and entrapping air to provide the insulative blanket with improved insulative qualities.

In another preferred embodiment, the reflective blanket may be provided with a reflective layer on each side. More specifically, a reflective layer is secured to the outside surface of each moisture-impervious layer. This permits the blanket to reflect radiant energy from the sun with minimal absorption by the blanket.

The present invention provides a simple, cost-effective, lightweight and moisture-impervious insulative blanket. The external reflective layer allows radiant energy to be reflected without passing through any portion of the blanket, thereby reducing heat retention by the blanket and providing improved lateral heat conduction and more uniform heat distribution. As a result of the moisture-impervious layers, the blanket does not leach or absorb moisture from curing concrete or the surrounding elements. By using the moisture-impervious layers to seal the indentations of the insulative layer, the present invention requires fewer layers than conventional “bubble-wrap” insulative blankets, and may therefore have less weight and be less expensive to manufacture.

These and other objects, advantages and features of the invention will be more fully understood and appreciated by reference to the detailed description of the preferred embodiments in the drawings.

### BRIEF DESCRIPTION OF THE DRAWINGS

FIG. 1 is an exploded, cross sectional view of an insulative blanket manufactured in accordance with the prior art;

FIG. 2 is a perspective view of a portion of an insulative blanket manufactured in accordance with a preferred embodiment of the present invention;

FIG. 3 is a cross sectional view of a portion of the insulative blanket taken along line III-III of FIG. 2;

FIG. 4 is a cross sectional view of a first alternative insulative blanket having reflective layers on both sides; and

FIG. 5 is a cross sectional view of a second alternative insulative blanket having a foam insulative layer.

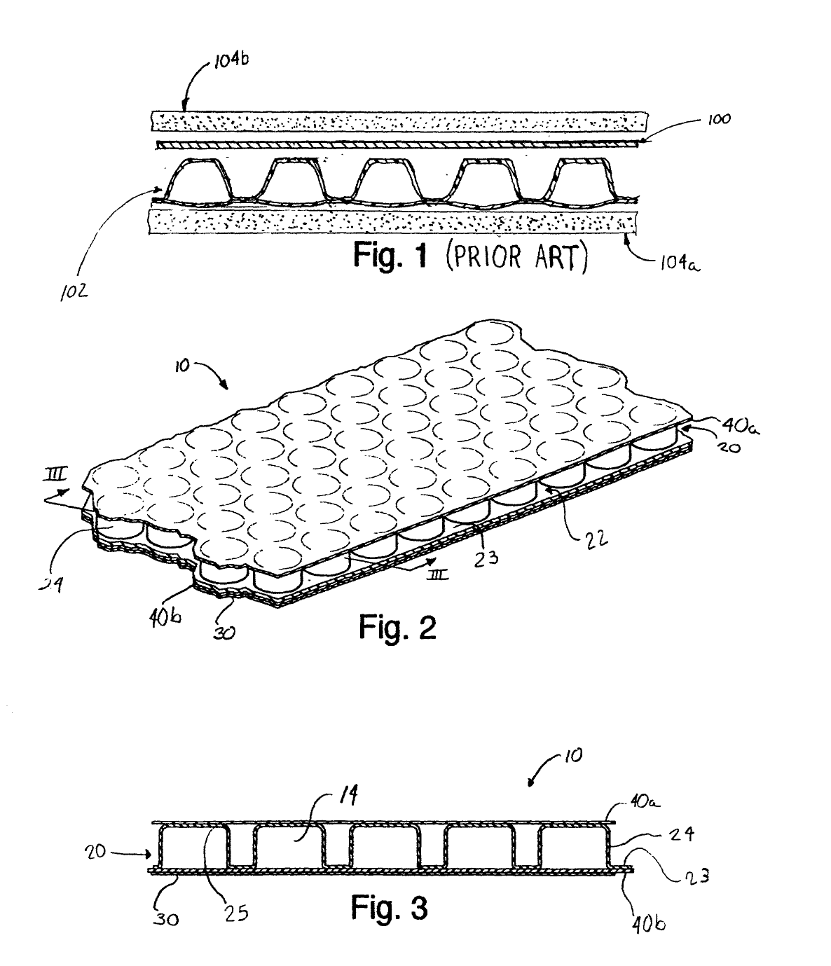

### DETAILED DESCRIPTION OF THE PREFERRED EMBODIMENTS

An insulative blanket constructed in accordance with the present invention is illustrated in FIGS. 2-3 and generally designated 10. As perhaps best shown in FIG. 3, the insulative blanket 10 generally includes an insulative layer 20, a pair of moisture-barrier layers 40a and 40b and a reflective layer 30. The moisture-barrier layers 40a and 40b are secured to each side of the insulative layer 20. The reflective layer 30 is laminated or otherwise secured to the outside of one of the moisture-barrier layers 40a or 40b. The present invention is described in connection with an insulative blanket adapted for use in standard construction applications. The present invention is, however, readily adapted for use in specialized applications, for example, by varying the material and or specifications of the moisture-impervious, insulative and reflective layers.

The insulative layer 20 includes a substantially planar base 23 having a plurality of protruding insulative elements 24, as perhaps best shown in FIGS. 2 and 3. The insulative elements 24 are preferably hollow, generally cylindrical elements arranged in a regular pattern over the entire extent of the insulative layer 20. The size, shape and arrangement of the insulative elements 24 can vary from application to application as desired. For example, the insulative elements 24 may take on other shapes, such as triangles, squares, elongate lines, troughs, ovals or essentially any other shape. The apexes 25 of the insulative elements 24 are preferably arranged in a co-planar configuration to provide a uniform surface to intersecure with the moisture-impervious layer 40a. As described in more detail below, the insulative elements 24 are sealed by the moisture-impervious layer 40b to provide the desired insulative properties. The insulative layer 20 is preferably manufactured from a substantially planar sheet of plastic material that is formed to define the insulative elements 24, as described in more detail below. To increase the efficiency of the insulative blanket 10, the insulative layer 20 is made out of materials that resist moisture absorption while providing the necessary insulative properties. In the preferred embodiment, the sheet 22 is manufactured out of a plastic material, an example of a suitable plastic is linear low-density polyethylene, with a thickness of 1-10 mils. It should be readily apparent that the sheet 22 may be formed with a variety of thicknesses and other types of plastics. Alternatively, the preferred insulative layer 20 may be replaced by other conventional insulative materials. For example, the insulative layer may be replaced by a layer of conventional “bubble wrap.” Further, the insulative layer may be made out of a variety of other synthetic or plastic materials such as closed cell polypropylene foam, closed cell polyethylene foam, polyester, nylon, or fibrous synthetic materials that maintain their insulative properties when wet, as shown in FIG. 5. If desired, the insulative layer 20 may also include multiple sheets secured together (not shown) or other configurations to provide greater insulation. Multiple blankets may also be laminated together to provide extra insulative properties while maintaining the ease of manufacturing by producing one standard blanket 10, which only is laminated to give the desired heat retention.

As noted above, the moisture-impervious layers 40a and 40b are secured to opposite sides of the insulative layer 20. The moisture-impervious layers 40a and 40b are generally planar sheets extending substantially coextensively with the insulative layer 20. In the preferred embodiment, moisture-impervious layer 40a is secured to the upper surfaces of the apexes 25 and moisture-impervious layer 40b is secured to the lower surface of the base 23. Moisture-impervious layer 40b seals the insulative elements 24 entrapping air within spaces 14. Similarly, moisture-impervious layer 40a seals the upper surface of the blanket 10 cooperating with the sealed edges of the blanket 10 to entrap air in the space defined around the insulative elements 24. The sealed air spaces 14 give the blanket 10 improved insulative qualities. The moisture-impervious layers 40a and 40b are made out of a thin flexible plastic to produce a lightweight insulative blanket 10. In the preferred embodiment, the moisture-impervious layers 40a and 40b are manufactured from polyethylene plastic having a thickness of approximately 1-4 mils. The thickness of the moisture-impervious layers 40a and 40b can vary from application to application with the type of material and the degree of durability required. The moisture-impervious layers 40a and 40b may also be made out of other materials such as nylon, polyester or other synthetic materials to provide variations in durability, flexibility and weight. If desired, the moisture-impervious layers 40a and 40b can be manufactured from heavier materials such as canvas, cloth or synthetic materials such as polyester or nylon, to give greater durability and reduce the likelihood of tearing, cutting or burning. Both the insulative layer 20 and moisture-impervious layers 40a and 40b may be manufactured out of a flame-retardant material and/or out of biodegradable and/or sunlight degradable material.

As described above, the reflective layer 30 is secured to the outer surface of one of the moisture-impervious layers 40a or 40b. The reflective layer 30 is preferably a thin sheet of metallic foil, such as aluminum foil, which provides a lightweight and inexpensive blanket. Alternatively, other materials may be used, such as tin, copper, nickel, zinc, and any other element or combination of elements so long as it provides a surface that is capable of reflecting radiant energy. The thickness of the reflective layer may vary, but in the preferred embodiment the reflective layer has a thickness of about 0.3 mils or greater. A thicker reflective layer may be used to provide increased lateral heat conduction. The reflective layer in some cases may also be made out of highly reflective non-metallic materials to provide greater flexibility and durability to the reflective layer. As an alternative to the use of a foil material, the reflective layer 30 may alternatively be deposited on the moisture-impervious layer 40a or 40b, such as by spray painting or vacuum deposition.

II. Method of Manufacture and Assembly

As noted above, the insulative blanket 10 is preferably manufactured out of plastic materials, although materials such as biodegradable, air degradable or light degradable plastics, foam insulations, synthetic materials or any other material that provides insulative properties while resisting the absorption of moisture may be used. In a preferred embodiment, the insulative layer 20 is formed from a sheet of flexible plastic, preferably linear low density polyethylene having a thickness of 5-15 mils. The plastic is preferably provided in the form of an elongate roll, although individual smaller pieces may be used. The insulative elements 24 are formed in the sheet using conventional techniques and apparatus. One technique is to move the plastic sheet 22 across a heated roller that includes a plurality of spaced indentations corresponding in size, shape and configuration to the desired insulative elements. A vacuum is created in each of the indentations to draw the sheet into the indentations, thereby forming the insulative elements 24. Alternatively, the insulative layer 20 may be formed by passing the plastic sheet 22 between two heated rollers, the first roller having indentations and the other having protrusions. These rollers form the insulative elements 24 by rolling the sheet 22 between them. The apexes 25 of the insulative elements 24 define an upper planar surface, while the base 23 defines the lower plane.

One or both of the moisture-impervious layers 40a and 40b are then applied to the insulative layer 20 using conventional techniques and apparatus. In some embodiments, the formed side of the insulative element 24 could serve as moisture-impervious layer 40a or 40b. The moisture-impervious layers 40a and 40b are formed in approximately the size of the insulative layer 20, but other sizes may be used and cut to fit the insulative layer 20. In the preferred embodiment, the moisture-impervious layers 40a and/or 40b are laminated to each side of the insulative layer 20 by adhesive, heat or other methods well known in the art. In some applications, the moisture-impervious layers 40a and/or 40b may be secured to the insulative layer 20 only along the peripheral edges of the blanket 10.

In the preferred embodiment, the reflective layer 30 is laminated or otherwise attached to at least one of the moisture-impervious layers 40a and 40b using conventional techniques and apparatus. The reflective layer 30 is preferably attached to the moisture-impervious layer 40a or 40b before the moisture-impervious layer 40a or 40b is attached to the insulative layer 20. It may, however, be attached to the moisture-impervious layer 40a or 40b after the moisture-impervious layer 40a or 40b is attached to the insulative layer 20. In the preferred embodiment, the reflective layer 30 is a metallic foil that is secured to the moisture-impervious layer 40a or 40b by heat lamination or adhesive or cement. Another method for manufacturing the reflective layer 30 is to apply a reflective material using conventional deposition techniques and apparatus. For example, the reflective material, such as a metallic paint, can be spray deposited on the outer surface of the moisture-impervious layer 40b. Alternatively, the reflective material can be applied using a conventional vacuum deposition technique.

The exterior edges of the insulative blanket 10 are preferably sealed to prevent moisture and other contaminants from entering the space around the insulative elements 24. The peripheral edge is preferably sealed by heat welding or by adhesively intersecuring the various layers of the blanket 10. Alternatively, a trim element (not shown) may be applied around the periphery of the blanket 10. For example, a flexible, plastic strip (not shown) may be folded around the edges and secured to the upper and lower surfaces of the blanket 10 by lamination or an adhesive.

### ALTERNATIVE EMBODIMENTS

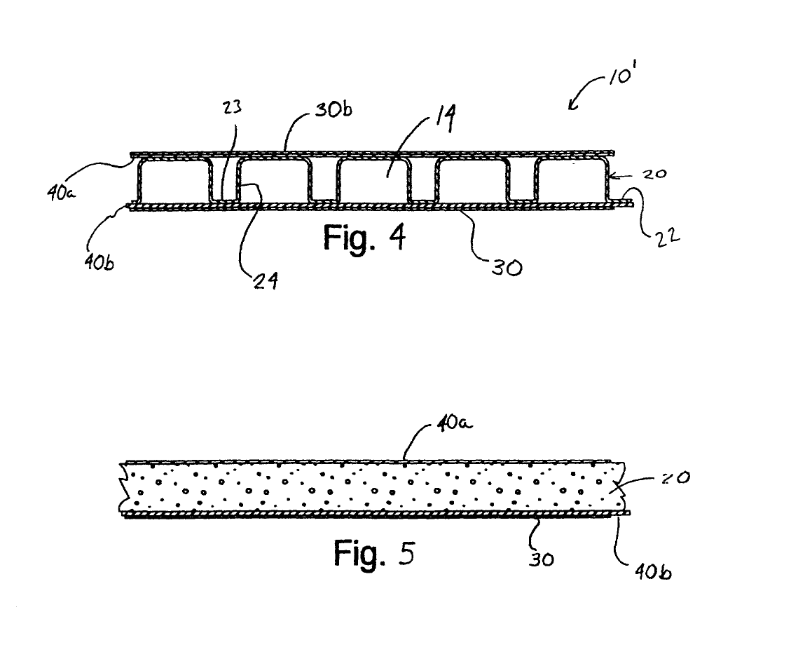

A first alternative embodiment is shown in FIG. 4. In this embodiment, the blanket 10′ includes a second reflective layer 30b disposed on moisture-impervious layer 40a. As a result, the blanket 10′ includes reflective layers 30 and 30b on both outer sides. The moisture-impervious layers 40a and 40b and reflective layers 30 and 30b may be manufactured by any of the methods above in connection with the preferred embodiment. The second reflective layer 30b is particularly useful in applications where it is desirable to reflect away the sun's radiant energy, such as in certain concrete curing applications.

In a second alternative embodiment (not shown), the insulative blanket 10 may be formed with only one of the moisture-impervious layers 40a and 40b. For example, the top moisture-impervious layer 40a may be omitted. The blanket 10 still retains its insulative qualities because the moisture-impervious layer 40b seals the insulative enclosures 14. Alternatively, the bottom moisture-impervious layer 40b may be omitted, so that the insulative layer 20 is bounded by the top moisture-impervious layer 40a on one side, and on the other side by the reflective layer 30, allowing the blanket 10 to retain its insulative qualities as described above in connection with the preferred embodiment.

In a third alternative embodiment (not shown), at least one of the moisture-impervious layers 40a or 40b is formed from a darker color, such as black, to absorb thermal energy from the sun during the day. This allows the insulative blanket 10 to absorb heat from the sun lowering the need for supplementary heat.

The above descriptions are those of preferred embodiments of the invention. Various alterations and changes can be made without departing from the spirit and broader aspects of the invention as defined in the appended claims, which are to be interpreted in accordance with the principles of patent law and the doctrine of equivalents.

The embodiments of the invention in which an exclusive property or privilege is claimed are defined as follows:

1. An insulative blanket comprising:
a first moisture-barrier layer;
a second moisture-barrier layer;
an insulative layer between said first moisture-barrier layer and said second moisture-barrier layer; and
a reflective layer attached to at least one of said first and said second moisture-barrier layers, said reflective layer being attached to said moisture-barrier opposite said insulative layer.

2. The insulative blanket of claim 1 wherein said reflective layer comprises a metal foil.

3. The insulative blanket of claim 2 wherein said metal foil is made of aluminum.

4. The insulative blanket of claim 1 wherein said insulative layer comprises a sheet, said sheet defining a plurality of indentations having a base and an apex, said first moisture-barrier layer laminated to one of said base and said apex, said second moisture-barrier layer laminated to the other of said base and said apex, said first moisture-barrier layer and said second moisture-barrier layer defining a space therebetween.

5. The insulative blanket of claim 1 wherein said insulative layer comprises a first sheet defining a plurality of indentations, said first sheet laminated to a second sheet closing said plurality of indentations, said enclosed indentations forming at least one insulative enclosure.

6. The insulative blanket of claim 1 wherein said insulative layer comprises a first sheet defining a plurality of indentations, said first sheet laminated to a second sheet, said laminated first sheet and said second sheet defining a first enclosed space, said first sheet laminated to a third sheet, said laminated first sheet and said third sheet defining a plurality of insulative enclosures.

7. The insulative blanket of claim 1 wherein said insulative layer is plastic.

8. An insulative blanket comprising:
an insulative layer having a base and a plurality of protrusions extended from said base;
a moisture-impervious layer secured to said base, said moisture-impervious layer closing said protrusions, said closed protrusions forming insulative enclosures; and
reflective layer secured directly to said moisture-impervious layer.

9. The insulative blanket of claim 8 wherein said reflective layer comprises a metallic foil.

10. The insulative blanket of claim 9 wherein said metallic foil is aluminum.

11. The insulative blanket of claim 8 wherein said moisture-impervious layer and said insulative layer comprise degradable materials.

12. The insulative blanket of claim 8 further comprising a second moisture-impervious layer secured to said protrusions, said moisture-impervious layer and said base forming at least one insulative enclosure.

13. The insulative blanket of claim 8 wherein said insulative layer is plastic.

14. The insulative layer of claim 8 wherein said moisture-impervious layer is plastic.

15. An insulative blanket comprising:
a first moisture-barrier layer having an inner surface and an outer surface;
a second moisture-barrier layer having an inner surface and an outer surface;
an insulative layer having an upper surface and a lower surface, said insulative layer defining a plurality of protrusions, said inner surface of said first moisture-barrier layer being secured to said upper surface of said insulative layer, said inner surface of said second moisture-barrier layer being secured to said lower surface of said insulative layer closing said protrusions to define a plurality of insulative elements; and
a reflective layer secured to at least one of said outer surface of said first moisture-barrier layer and said outer surface of said second moisture-barrier layer.

16. The insulative blanket of claim 15 wherein said plurality of insulative enclosures are disposed in a spaced relationship with each other, said elements being air filled pockets.

17. The insulative blanket of claim 15 comprising a plurality of said insulative layers between said first moisture-barrier layer and said second moisture-barrier layer.

18. The insulative blanket of claim 15 wherein said reflective layer comprises a metallic foil.

19. The insulative blanket of claim 15 wherein said insulative layer and said moisture-impervious layers are plastic.

20. The insulative blanket of claim 19 wherein said plastic is degradable.

21. The insulative blanket of claim 15 wherein at least one of said moisture-impervious layers is formed from a dark color.

22. An insulative blanket comprising:
an insulative layer and a moisture-impervious layer, said moisture-impervious layer being attached to said insulative layer; and
a reflective layer secured directly to either of said moisture-impervious layer and said insulative layer, said reflective layer forming an outer surface of said blanket.

23. The insulative blanket of claim 22 wherein said insulative layer further comprises a base and a plurality of protrusions extending from said base, each of said protrusions including an apex, said moisture-impervious layer secured to said apexes, said base and said moisture-impervious layer defining at least one insulative enclosure.

24. The insulative blanket of claim 23 wherein said reflective layer is secured to said base.

25. The insulative blanket of claim 23 wherein said reflective layer is secured to said moisture-impervious layer.

26. The insulative blanket of claim 22 comprising a second moisture-impervious layer secured to said base closing said protrusions, said closed protrusions forming insulative enclosures.
